(19) United States
(12) Patent Application Publication
(10) Pub. No.: US 2004/0220792 A1
(43) Pub. Date: Nov. 4, 2004

(54) Performance modeling for information systems

(76) Inventors: Peter Thomas Gallanis, Highlands Ranch, CO (US); Thomas Joseph Holloran, Parker, CO (US); Mark Samuel Teflian, Parker, CO (US); Scott Thurston Sleeper, Franktown, CO (US); Bruce Allen Bacon, Lone Tree, CO (US)

Correspondence Address: MERCHANT & GOULD PC, P.O. BOX 2903, MINNEAPOLIS, MN, 55402-0903, US

(21) Appl. No.: 10/427,121

(22) Filed: Apr. 30, 2003

(51) Int. Cl. G06F 17/50; G06G 7/62

(52) U.S. Cl. 703/13

(57) ABSTRACT

A method for monitoring performance of an IT-based computing system over the life cycle of the system is disclosed. The life cycle includes a conception phase, an analysis phase, an architecture design phase, a system design phase, a construction phase, a testing phase, a deployment phase, and finally, an operational phase. Performance requirements for the IT-based computing system are defined during the analysis phase. In the architecture design phase, the appropriate hardware and software infrastructure are selected for use in designing the base architecture for the system. In the system design phase, application specific system components are defined for the system. In the construction phase, the hardware platform is assembled and the software design specifications are turned into executable code. The constructed system is then tested for functionality and performance prior to being deployed for subsequent operation. A performance model is created during the analysis phase using the performance requirements. The model, which is refined during each phase in the life cycle to more accurately reflect the system being constructed, may be executed at any phase in the life cycle to render optimal levels of performance for the system at that phase. Furthermore, the refined model may be used during the operational phase of the life cycle to test the effect of enhancing a pre-existing IT-based computing system.

### TECHNICAL FIELD

The invention relates generally to information systems, and more particularly, to analyzing performance of information systems.

### BACKGROUND OF THE INVENTION

Information technology (“IT”) based computing systems are commonly used within businesses, universities, government entities and the like (hereinafter, “companies”) to provide employees with access to electronic files as well as a medium for communicating internally and externally with others. As a company grows geographically and in employee size, so does the need for that company to implement, if it hasn't already, an IT-based computing system. Likewise, growth by companies with an existing IT-based computing system normally results in the need for enhancements to the system.

Many different processes have been used in the development, implementation and enhancing of IT-based computing systems. These processes have multiple names based on the theory under which they were developed. Each of these processes, however, share a number of common activities. FIG. 1 illustrates an exemplary lifecycle 100 for an IT-based computing system that includes each of these commonly shared activities. Generally defined, a life cycle for an IT-based computing system is a process incorporating all activities, or phases, associated with conception, design, creation and implementation of the IT-based computing system.

FIG. 1 represents a typical prior art process encompassing various phases associated with a life cycle 100 of an IT-based computing system. The initial phase of the life cycle 100 relates to the conception 102 of the IT-based computing system. Oftentimes, the conception phase 102 includes mental thoughts and processes related to assessment of the environment in which the system is to be implemented. For instance, the need to store and manipulate large amounts of data for a business may lead to a conclusion that a client-server network should be implemented within the business. Following conception, an analysis phase 104 is performed wherein the company identifies the requirements of the conceived system. Often, these requirements are functional and aligned to the business objectives of the system. After the requirements for the conceived system are identified, the life cycle 100 proceeds to an architecture design phase 106. In the architecture design phase 106, one or more computing system architects design the base architecture for the system. Typically, the base architecture includes the hardware and software infrastructure, i.e., components, which will be used as the building blocks for the IT-based computing system. Furthermore, the architects design the function and placement within the system for the selected hardware components, including, for instance, database systems, middleware components, network components, e.g., user terminals and server systems, as well as the development language(s) to be used in coding the software infrastructure.

After the architecture for the system has been designed, the life cycle 100 proceeds to a system design phase 108. In the system design phase 108, application specific system components for the IT-based computing system are defined. These components include, for example, application programming interfaces (“API's”), data structures and business logic. Following the system design phase 108 and the architecture design phase 106, the design of the IT-based computing system conceived at the beginning of the life cycle 100 is considered to complete, and thus, the system is ready for construction.

The system is constructed during the construction phase 110 shown in the life cycle 100. In this phase, the hardware platform is assembled and the software design specifications are turned into executable code. From the construction phase 110, the system is tested at the test phase 112 to ensure that it meets the functional requirements established in the analysis phase 104. This functional testing typically includes evaluating the system as a whole to determine whether the software and hardware infrastructure, and components thereof, work properly together in the manner anticipated by the designers. The architecture design phase 106, the system design phase 108, the construction phase 110 and the test phase 112 are collectively known as the “creation” phases because the IT-based system is actually designed and reduced to practice during the time span in which these phases occur.

Upon satisfying these functional requirements, the system is placed into a production environment during the deployment phase 114. A production environment refers to the environment in which the system is to be implemented. At deployment, the production environment is typically a “limited” in that only a subset of the total usage that will be applied to the system during actual implementation is actually applied to the system. As such, deployment typically involves the creation of production and operational procedures and documentation, creation of the production hardware and software environment, and the initial implementation providing access to targeted users. Even though a system has been deployed, it must still be supported, maintained, and operated. As such, the life cycle 100 proceeds from the deployment phase 114 into an operational phase 116, where the system is operated within the production environment for the remainder of the life cycle 100. In this phase, updates to production systems and the supporting infrastructure are applied to the production system in order for the system to maintain currency. Furthermore, daily production runs may require special configurations. The life cycle 100 of the system remains in the operational phase 116 until the system is taken out of the production environment.

Although the above-noted systematic approach defining the life cycle of an IT-based computing system has been widely adopted for designing, developing, deploying and operating IT-based computing systems, this approach is not without shortfalls. With most systems, the prospective success of the system is predicted only on endorsements/recommendations from satisfied customers of the hardware/software vendors. In fact, statistics show that only 15-20% of the implemented IT-based computing systems actually meet performance objectives established during conception of the system. Performance objectives are commonly defined as levels of performance (hereinafter, “performance levels”) related to functions of an IT-based computing system operating under applied workload conditions. For example, performance levels of an IT-based computing system may relate to the number of transactions the system can perform in a defined period of time, the amount of time it takes the system to process a transaction and return a response to a user, the number of users that can be supported by the system, the amount of time the system is available to users or the ability of the system to otherwise support any related business or economic objectives.

IT-based computing systems are often “re-worked” after deployment in order to reach performance levels sufficient to meet the business objectives set out during the analysis phase 104. The obvious result is additional expense and time delays in the life cycle to reach the operational phase 116. These cost over-runs and delays have a direct effect on the ability of the company to achieve the desired economic benefits of the system.

One prior art method for addressing performance level failure of a system after deployment is to evaluate performance, and not just functionality, of the system during the testing phase 112. Performance evaluation typically includes stress testing applications, system components and network components to determine if they will be able to support a defined, or bounded, workload, and therefore perform as originally contemplated. Although evaluating performance prior to the deployment phase 114 has proven to improve costs and shorten time delays between the deployment phase 114 and the operation phase 116, this process still does not provide an optimal solution for attaining desired performance levels because the system has already been constructed. Even if a performance failure is detected during this evaluation, the expense of correcting such a failure, coupled to the fact that system must be re-designed or, at least re-constructed, sometimes outweighs the benefit of meeting the desired performance level. Thus, many systems are deployed with the understanding that they will not perform to accomplish the requirements originally defined by the company purchasing the system. As such, many systems placed into production immediately begin decreasing the company's return on investment at operation.

### SUMMARY OF THE INVENTION

In accordance with the present invention, the above and other problems are solved by a modeling approach for use in designing, developing and implementing IT-based computing systems. The modeling approach is a dynamic modeling process in which a model for a conceptual IT-based computing system is created during at an early phase in the system's life cycle and used during each subsequent phase to define and refine performance of the system under design, creation or operation. The model, as applied to each of these subsequent phases of the life cycle, is used to define and refine performance of the system by providing architects, designers, developers and operators with performance levels that may be expected based on requirements defined for the system. If the system, at any one phase, does not comply with the expected performance levels rendered by the model, appropriate corrections may be made to the system at a time prior to entering the next phase of the life cycle. At the conclusion of each phase in the life cycle, the model may be refined to more accurately depict the current system.

In an embodiment, the model is created during an analysis phase using requirements associated with the intended performance of the system. Once created, the model is executed to render levels of performance desired for the system. Performance levels are generally defined as performance metrics or characteristics that the system is to adhere to relative to the phase in the life cycle that the system is currently in. In one embodiment, the performance levels are relative values defining a range to which the system should comply. In a second embodiment, the performance levels may be definite values to which the system should comply.

Once created, the model is used during the creation phases, i.e., architecture design, system design, system construction and testing, of the life cycle of the IT-based computing system to check the current performance of the system following completion of each phase. The system, currently under creation, is compared against the model for verification that the system can provide the desired performance levels expected by the system at that phase in its creation. If this comparison renders the system inoperable to perform at the desired levels, the entity responsible for development at the current phase is provided an indication that one or more features of the system should be corrected prior to entering the next phase in the life cycle.

In another embodiment, the model is updated to reflect the components, both software and hardware, and functionality of the system in the current phase after the system is deemed to perform at the desired levels for that phase. Further, the model may even be updated to reflect the performance levels of the system in the current phase if it is determined that the actual performance levels are desired over the performance levels rendered by the model. At the time when the system is deployed, the model has thus been refined during creation to accurately reflect the performance levels actually rendered by the operating system.

In accordance with yet another embodiment, the model is used during operation of the system as a tool for determining whether the system is performing at the desired levels. As such, operating parameters of the system are continuously compared to the performance levels of the model to verify operation of the system. A departure from the desired performance levels may lead to a determination that a software or hardware component in the system has failed. In even a further embodiment, the model may be refined based on operation of the system. Such an embodiment may be useful if it is determined that the actual performance levels are desired over the performance levels rendered by the model.

The invention may be implemented as a computer process, a computing system or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

One great utility of the invention is that overall performance of an IT system more accurately meets the requirements defined in the early phases of the system's life cycle, thereby providing the company requesting the system with a satisfactory return on investment by achieving the desired economic benefits. Furthermore, the ability to create and refine a model for a system leads to a more efficient design and development of any enhancements to the system. These and various other features as well as advantages, which characterize the present invention, will be apparent from a reading of the following detailed description and a review of the associated drawings.

### BRIEF DESCRIPTION OF THE DRAWINGS

FIG. 1 illustrates various phases of a prior art life cycle for an IT-based computing system in accordance with various prior art implementations.

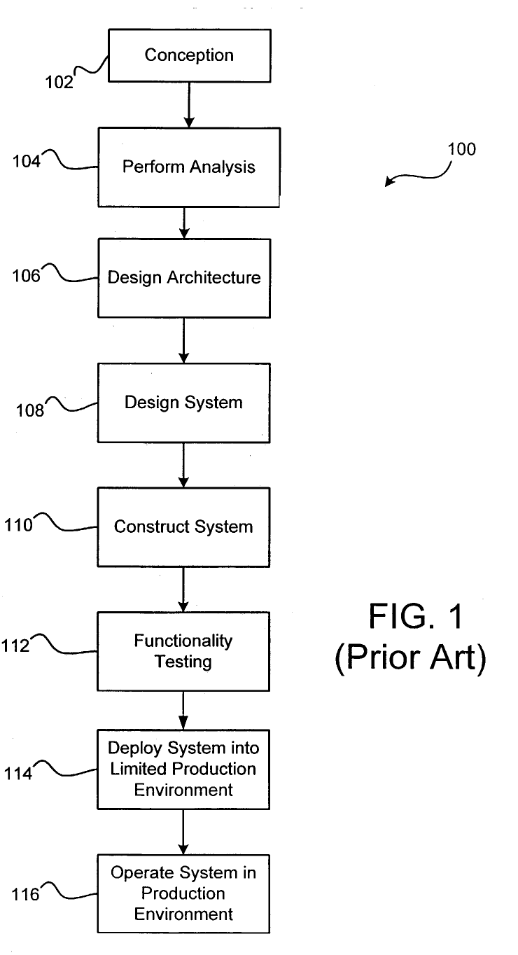

FIG. 2 shows a client-server network for use as an IT-based computing system in accordance with an exemplary embodiment of the present invention.

FIG. 3 depicts a block diagram of a suitable computing environment in which an embodiment of the present invention may be implemented.

FIG. 4 is a flow diagram that illustrates operational characteristics of a process for monitoring performance of an IT-based computing system during the life cycle of the system in accordance with an embodiment of the present invention.

FIG. 5 is a flow diagram that illustrates the process shown in FIG. 4 in more detail in accordance with an embodiment of the present invention.

FIG. 6 is a flow diagram that illustrates operational characteristics of a process for creating a model of an IT-based computing system and refining the model to reflect performance characteristics of the system during each phase in the life cycle of the system in accordance with an embodiment of the present invention.

FIG. 7 is a flow diagram that illustrates the process shown in FIG. 6 in more detail in accordance with an embodiment of the present invention.

FIG. 8 is a flow diagram that illustrates operational characteristics for enhancing an existing IT-based computing system using the model created and refined by the process shown in FIG. 6 in accordance with an embodiment of the present invention.

### DETAILED DESCRIPTION

In the following description of the exemplary embodiment, reference is made to the accompanying drawings that form a part hereof, and in which is shown by way of illustration the specific embodiment in which the invention may be practiced. It is to be understood that other embodiments may be utilized as structural changes may be made without departing from the scope of the present invention.

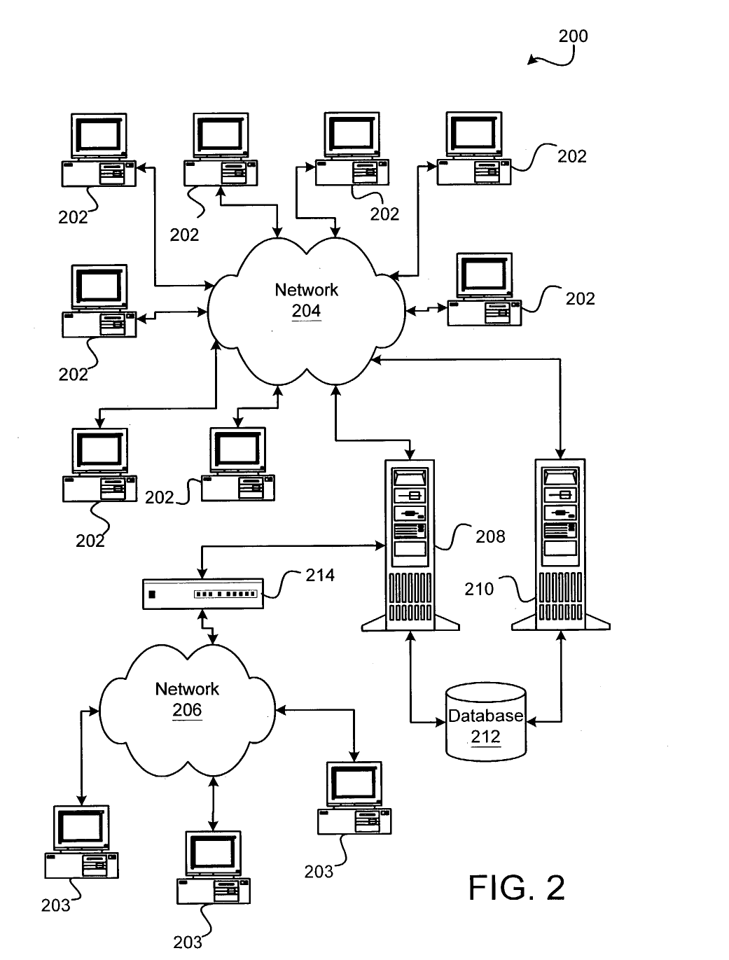

Referring to FIG. 2, a conceptual illustration of an IT-based computing system 200 is shown in accordance with an exemplary embodiment of the present invention. In this embodiment, the IT-based computing system 200 is a client-server network utilized as the communication and data storage/retrieval system for a company. The IT-based computing system 200 includes a plurality of on-site client computers 202, off-site client computers 203 and at least one central server 208. The central server 208 is communicatively coupled to a central database 212. The IT-based computing system 200 may also include an alternate central server 210 communicatively coupled to the central database 212. The central database 212 stores files for use by the on-site client computers 202 and the off-site client computers 203. The on-site client computers 202 represent user terminals, or stations, internal to the company. In contrast, the off-site client computers 203 represent user computers located external to the company. Examples of off-site client computers 203 include, for example, laptop computers, home computers, personal digital assistants, mobile telephones, pagers, etc.

The client computers 202 and 203 access files stored on the central database 212 by connecting to, i.e., communicating with, the central server 208 by way of a communications network, e.g., 204 and 206. In an embodiment, the communications network 204 by which the on-site client computers 202 connect to the central server 208 represents an intranet, whereas the communications network 206 by which the off-site client computers 203 connect to the central server 208 represents the Internet. As such, a conventional router 214 is used to transmit information between off-site client computers 203 and the central server 208.

It should be understood that the communications networks, e.g., 204 and 206, may utilize any number of communication technologies depending on functions required by the embodiment. Examples of specific technologies used in communications networks, e.g., 204 and 206, contemplated include, without limitation, terrestrial, cellular, satellite, short-wave, and microwave connections to the Internet or an intranet, directly between facilities using modems or other interface devices, e.g., router 214, or through other communications networks, such as local area networks or wide area networks. Any combination of these or other communications networks may be utilized and remain within the scope of the invention.

With the conceptual environment of an IT-based computing system, e.g., IT-based computing system 200, in mind, the present invention generally provides a method for monitoring performance of the system during the system's life cycle in accordance with one embodiment. In accordance with another embodiment, the present invention generally provides a method for enhancing an IT-based computing system operating in a production environment. In accordance with yet another embodiment, the present invention generally provides a method for developing an IT-based computing system for use in a production environment.

The various embodiments of the present invention may be implemented manually and/or as a computer-readable program storage device which tangibly embodies a program of instructions executable by a computer system for defining a strategic alliance within a specified technological market. As such, the logical operations of the various embodiments of the present invention may be implemented: (1) manually; (2) as a sequence of computer implemented acts or program modules running on a computing system and/or (2) as interconnected machine logic circuits or circuit modules within the computing system. The implementation is a matter of choice, and therefore, the logical operations making up the embodiments of the present invention described herein are referred to variously as operations, structural devices, acts or modules. It will be recognized by one skilled in the art that the operations, structural devices, acts and modules executed on a computer-readable program storage device may be implemented in software, in firmware, in special purpose digital logic, and any combination thereof without deviating from the spirit and scope of the present invention as recited within the claims attached hereto.

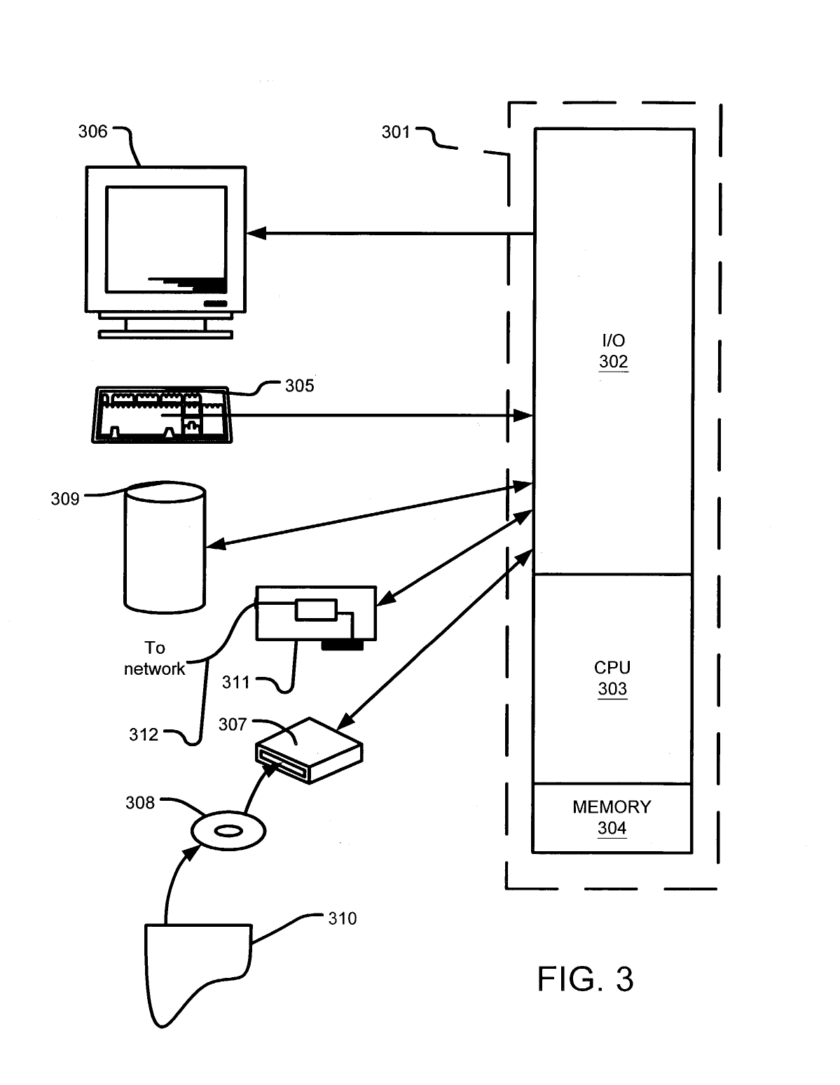

FIG. 3 and the following discussion are intended to provide a brief, general description of a suitable computing environment in which an embodiment of the present invention may be implemented. Although not required, embodiments of the present invention will be described in the general context of computer-executable instructions, such as program modules, objects, components, data structures, etc. that perform particular tasks or implement particular abstract data types. Moreover, those skilled in the art will appreciate that the invention may be practiced with other computing system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may reside in both local and remote memory storage devices.

FIG. 3 depicts a general-purpose computing system 300 capable of executing a program product embodiment of the present invention. One operating environment in which the present invention is potentially useful encompasses the general-purpose computing system 300. In such a system, data and program files may be input to the computing system 300, which reads the files and executes the programs therein. Some of the elements of a general-purpose computing system 300 are shown in FIG. 3 wherein a processor 301 is shown having an input/output (I/O) section 302, a Central Processing Unit (CPU) 303, and a memory section 304. The present invention is optionally implemented in software devices loaded in memory 304 and/or stored on a configured CD-ROM 308 or storage unit 309 thereby transforming the computing system 300 to a special purpose machine for implementing the present invention.

The I/O section 302 is connected to keyboard 305, display unit 306, disk storage unit 309, and disk drive unit 307. In accordance with one embodiment, the disk drive unit 307 is a CD-ROM driver unit capable of reading the CD-ROM medium 308, which typically contains programs 310 and data. Computer program products containing mechanisms to effectuate the systems and methods in accordance with the present invention may reside in the memory section 304, on a disk storage unit 309, or on the CD-ROM medium 308 of such a system. Alternatively, disk drive unit 307 may be replaced or supplemented by a floppy drive unit, a tape drive unit, or other storage medium drive unit. The network adapter 311 is capable of connecting the computing system 300 to a network of remote computers via the network link 312. Examples of such systems include SPARC systems offered by Sun Microsystems, Inc., personal computers offered by IBM Corporation and by other manufacturers of IBM-compatible personal computers, and other systems running a UNIX-based or other operating system. A remote computer may be a desktop computer, a server, a router, a network PC (personal computer), a peer device or other common network node, and typically includes many or all of the elements described above relative to the computing system 300. Logical connections may include a local area network (LAN) or a wide area network (WAN). Such networking environments are commonplace in offices, enterprise-wide computer networks, intranets, and the Internet.

In accordance with a program product embodiment of the present invention, software instructions such as those directed toward communicating data between a client and a server; detecting product usage data, analyzing data, and generating reports may be executed by CPU 303, and data such products usage data, corporate data, and supplemental data generated from product usage data or input from other sources may be stored in memory section 304, or on disk storage unit 309, disk drive unit 307 or other storage medium units coupled to the system.

As is familiar to those skilled in the art, the computing system 300 further comprises an operating system and usually one or more application programs. The operating system comprises a set of programs that control the operation of the computing system 300, control the allocation of resources, provide a graphical user interface to the user and includes certain utility programs. An application program is software that runs on top of the operating system software and uses computer resources made available through the operating system to perform application specific tasks desired by the user. Preferably, the operating system employs a graphical user interface where the display output of an application program is presented in a rectangular area on the screen of the display device 306 and is also multitasking (executing computing tasks in multiple threads), such as Microsoft Corporation's “WINDOWS 95”, “WINDOWS 98”, “WINDOWS 2000” or “WINDOWS NT” operating systems, IBM's OS/2 WARP, Apple's MACINTOSH SYSTEM 8 operating system, X-windows, etc.

In accordance with the practices of persons skilled in the art of computer programming, the present invention is described below with reference to acts and symbolic representations of operations that are performed by the computing system 300, a separate storage controller or a separate tape drive (not shown), unless indicated otherwise. Such acts and operations are sometimes referred to as being computer-executed. It will be appreciated that the acts and symbolically represented operations include the manipulations by the CPU 303 of electrical signals representing data bits which causes a resulting transformation or reduction of the electrical signal representation, and the maintenance of data bits at memory locations in the memory 304, the configured CD-ROM 308 or the storage unit 309 to thereby reconfigure or otherwise alter the operation of the computing system 300, as well as other processing signals. The memory locations where data bits are maintained are physical locations that have particular electrical, magnetic, or optical properties corresponding to the data bits.

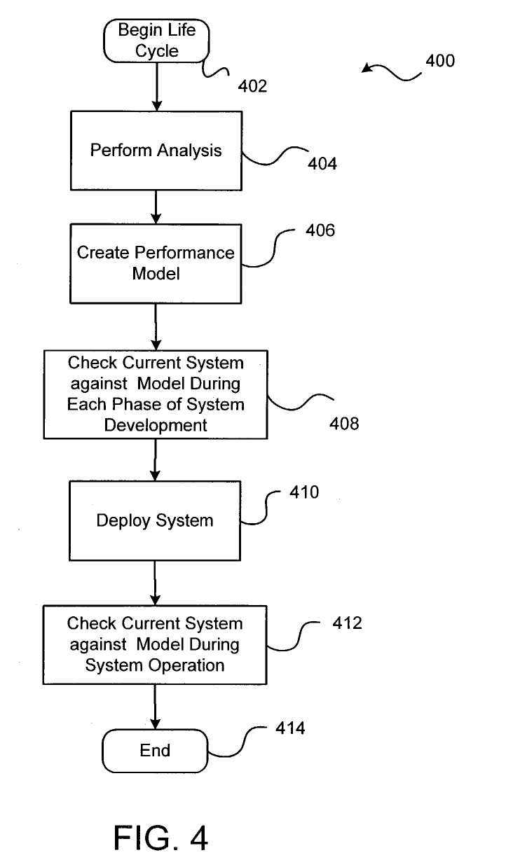

Now turning to FIG. 4, shown therein is a process 400 for monitoring performance of an IT-based computing system during the system's life cycle in accordance with an embodiment of the present invention. As described in greater detail below, the monitoring process 400 includes an operation for creating a performance model for the IT-based computing system being monitored. Although refinement of the performance model is not explicitly described with reference to the monitoring process 400, it should be appreciated that an embodiment of the invention contemplates refining the model at any phase relating to the design, creation or actual implementation, i.e., operation, of the IT-based computing system.

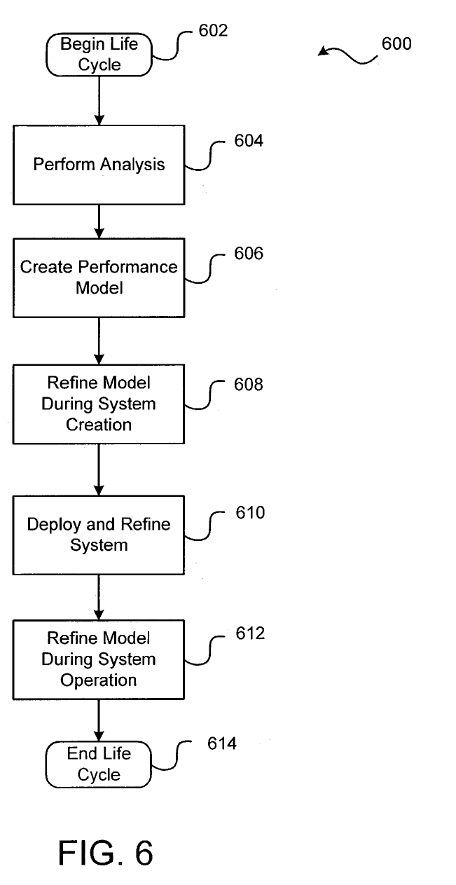

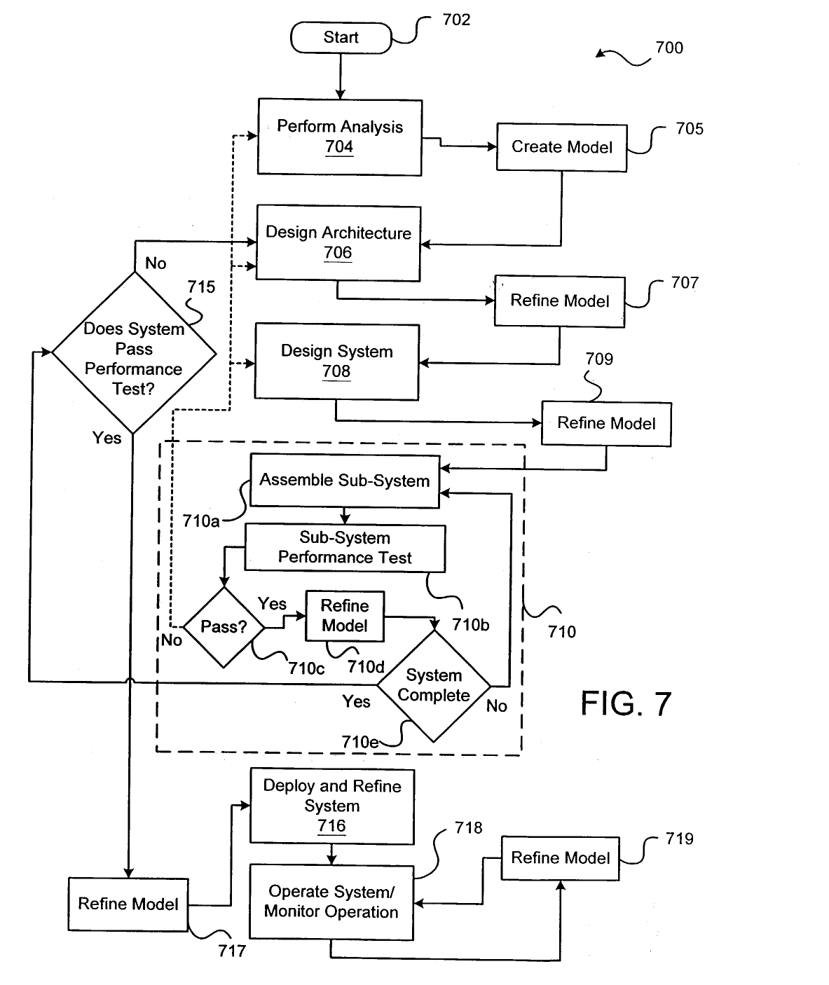

A process illustrating in more detail operations for refining a performance model throughout the life cycle of an IT-based computing system is shown in FIGS. 6 and 7, infra. The refinement operations shown in FIGS. 6 and 7 may indeed be performed concurrently with the monitoring process 400 in accordance with an embodiment of the present invention. In this embodiment, the performance model is refined at the conclusion of each phase in the life cycle based on current design, creation or operational aspects collected by implementation of the system at the current phase. Such an embodiment may be particularly useful if it is determined that the actual performance levels are desired over the performance levels rendered by the model.

The monitoring process 400 is performed using a flow of operations (“operation flow”) initiated at the beginning 402 of the life cycle, e.g., 100, for a conceptual IT-based computing system. At this point in time, the IT-based computing system is therefore represented as an “idea” for implementation by a company. After conception of the IT-based computing system, the operation flow passes to an analysis operation 404. The analysis operation 404 encompasses one or more manual and/or computer implemented processes performed during an analysis phase of the life cycle of the IT-based system in accordance with an embodiment of the present invention. The purpose of the analysis operation 404 is to gain an understanding of not only the functional requirements for the IT-based computing system, but also the performance requirements in accordance with an embodiment of the present invention.

As noted in the background, functional requirements relate to the business objectives of the system, i.e., the overall function, purpose and reasoning behind conception of the system. For example, a functional requirement may be for the company to provide an IT-based computing system that can be accessed by a plurality of off-site client computers (e.g., 203) over an Internet connection. Performance requirements, which may also be referred to as “service levels,” relate to actual performance standards or characteristics for the IT-based computing system, assuming that the system is functioning properly, i.e., as expected. For example, various performance requirements may include a desired response time, a desired throughput speed, expected volume of users at any given time, availability of the IT-based computing system, resiliency of the system and reliability of the system. Another performance requirement includes usage scenarios identifying different types of workloads that the IT-based computing system is to process at either random, scheduled or periodic times.

After the functional and performance requirements are defined by the analysis operation 404, the operation flow passes to create model operation 406. The create model operation 406 creates the initial performance model for the IT-based computing system under construction. In an embodiment, the create model operation 406 uses the functional and performance requirements defined during the analysis operation 404 to create the initial performance model. As such, the initial performance model is built as early in the IT-based computing system's life cycle as possible, and therefore is based on early level requirements established prior to initial design of the system. In accordance with an embodiment, the performance model is constructed using discrete event simulation modeling software. From the create model operation 404, the operation flow passes to a create system operation 408.

The create system operation 408 encompasses one or more manual and/or computer-implemented processes performed during an architecture design phase, a system design phase, a construction phase and a test phase of the life cycle of the IT-based system in accordance with an embodiment of the present invention. The create system operation 408 develops the IT-based computing system based on the performance model created by the create model operation 406 and, in an embodiment, refined during each subsequent phase of the system's life cycle. The create system operation 408 includes checking the system at the conclusion of each phase of the life cycle against the current performance model to determine whether the system at each phase conforms to desired performance levels associated with each respective phase. Performance levels, which are originally derived based on the performance requirements established during the analysis operation 404, are generally defined as performance metrics or characteristics that the system is to adhere to relative to the phase in the life cycle that the system is currently in. In one embodiment, the performance levels are relative values defining a range to which the system should comply. In a second embodiment, the performance levels may be definite values to which the system should comply.

In an embodiment, the create system operation 408 refines the performance model to reflect the components, both software and hardware, and functionality of the system in the current phase after the system is deemed to perform at the desired levels for that phase. Further, creation operation 408 may even update the performance model to reflect the performance levels of the system in the current phase if it is determined that the actual performance levels are desired over the performance levels rendered by the model. After the performance model has been applied to the system at each of the creation phases of the life cycle, i.e., the architecture design phase, the system design phase, the construction phase and the test phase, and it has been determined by the create system operation 408 that the current system complies with service levels rendered by the model at each phase in the system's life cycle, the operation flow passes to a deployment operation 410.

The deployment operation 410 encompasses one or more manual and/or computer-implemented processes performed during the deployment phase of the life cycle of the IT-based system in accordance with an embodiment of the present invention. The deployment operation 410 monitors the system as it is deployed first to a limited audience and subsequently to the intended production environment. To accomplish this, the deployment operation 410 applies the current performance model, i.e., the model as it is refined after the create system operation 408, if at all, to the deployed IT-based computing system. As with the create system operation 408, the deployment operation 410 determines whether the deployed system conforms to desired performance levels rendered by the model. If the performance levels are satisfied, the operation flow passes to an implement operation 412. If, however, the performance levels are not satisfied, the operation flow continues at the deployment operation 410 until either the IT-based computing system or the performance model are refined such that the system complies with the performance model. It should be appreciated, as stated, that the model, the actual system or both may be refined in accordance with various embodiments. As such, there are circumstances where the model my be refined, but not the actual system. In these circumstances, the deployment operation 410 may have determined that the actual performance levels are desired over the performance levels rendered by the model. The deployment operation 410 may therefore refine the model to accurately reflect the performance levels actually rendered by the operating system. Upon agreement between actual operation of the deployed system and the service levels rendered by the performance model, the operation flow passes to the implement operation 412.

The implement operation 412 operates the deployed IT-based computing system in the intended production environment. The implement operation 412 encompasses one or more manual and/or computer-implemented processes performed during the operational phase of the life cycle of the IT-based system in accordance with an embodiment of the present invention. The implement operation 412 either periodically or randomly checks the actual operation of the IT-based computing system against the final performance model, i.e., the model as it is refined after the deployment operation 410, if at all. If the actual operation does not satisfy the performance levels rendered by the performance model, the system operator is provided an indication of system malfunction. As with the other phases in the life cycle, the performance model may be refined with actual results taken during the operational phase 116. As such, even after the system is refined, the present invention, in one embodiment, provides for the refinement of the performance model such that the current model is an accurate representation of the performance of the operating system. The operation flow continues in the implementation operation 412 until the IT-based computing system is removed from the production environment. At which time, the life cycle has concluded and the operation flow terminates at a finish operation 414.

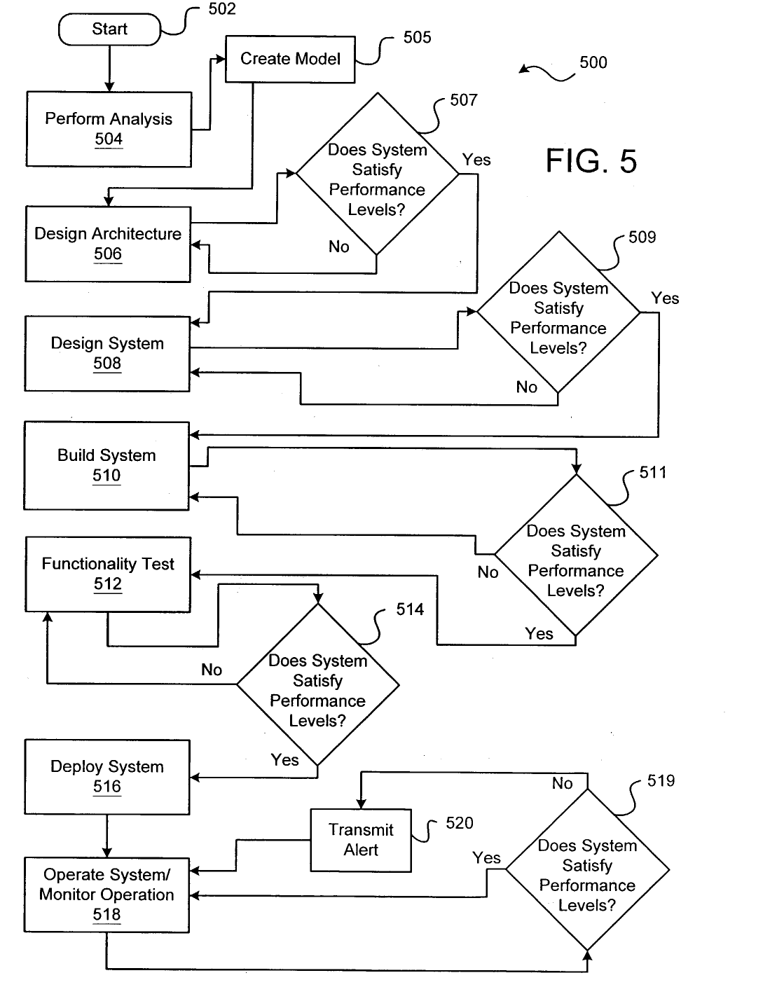

Referring now to FIG. 5, shown therein is a procedural flow diagram (“monitoring procedure 500”) illustrating operational characteristics of the monitoring process 400 in more detail in accordance with an embodiment of the present invention. More specifically, the monitoring procedure 500 illustrates interaction between the monitoring process 400 and operations occurring in each of the various phases of the life cycle, e.g., 100, of an IT-based computing system. The monitoring procedure 500 begins with a start operation 502 initiated at the beginning of the life cycle, e.g., 100, for a conceptual IT-based computing system. At this point in time, the IT-based computing system is therefore represented as an “idea” for implementation by a company. After conception of the IT-based computing system, the operation flow passes to an analysis operation 504.

The analysis operation 504 encompasses one or more manual and/or computer-implemented processes performed during an analysis phase of the life cycle of the IT-based system in accordance with an embodiment of the present invention. The purpose of the analysis operation 504 is to gain an understanding of not only the functional requirements for the IT-based computing system, but also the performance requirements in accordance with an embodiment of the present invention. Performance requirements are broadly defined as the desired performance levels for the IT-based computing system. After the functional and performance requirements are defined by the analysis operation 404, the operation flow passes to create model operation 505.

The create model operation 505 creates the initial performance model for the IT-based computing system under construction. In an embodiment, the create model operation 505 uses the functional and performance requirements defined during the analysis operation 504 to create the initial performance model. As such, the initial performance model is built as early in the IT-based computing system's life cycle as possible, and therefore is based on early level requirements established prior to initial design of the system. In accordance with an embodiment, the performance model is constructed using discrete event simulation modeling software. From the create model operation 505, the operation flow passes to an architecture design operation 506.

The architecture design operation 506 encompasses one or more manual and/or computer-implemented processes performed during an architecture design phase of the life cycle of the IT-based system in accordance with an embodiment of the present invention. The architecture design operation 506 designs the base architecture for the IT-based computing system by selecting components operable to provide the performance and functional requirements for the system. For example, if one of the functional requirements for the IT-based computing system is that the system provide routing capabilities to external networks, the components selected by the architecture design operation 506 may include an Internet router. In accordance with an embodiment, the components selected by the architecture design operation 506 may include custom off-the-shelf hardware products, custom developed code, existing frameworks and software. The components selected by the architecture design operation 506 may therefore include both software and hardware components. As such, the architecture design operation 506 selects the hardware and software infrastructure for the system.

A component may be selected by the architecture design operation 506 as part of the hardware or software infrastructure for use in a manner in which the company has not used the component in previous implementations. In such cases, “proof of concept” testing is performed by the architecture design operation 506 to develop a performance profile for that component in accordance with an embodiment of the present invention. Based on the performance budget, computer architects may determine in advance whether that component will work within the system, while maintaining the desired performance levels. After the base architecture has been designed and proof of concept testing, if any, is completed, the operation flow passes from the architecture design operation 506 to a first model check operation 507.

The first model check operation 507 compares the performance levels rendered by the executed model against actual performance test results of the base architecture. In an embodiment, the performance levels to which performance of the base architecture are compared reflect performance of the system expected at the architectural design phase 106, and not the operational phase 116. In another embodiment, the performance results taken from the architectural base may represent estimated operating parameters. In this embodiment, the performance levels to which the performance results are compared reflect performance of the system during operation.

In either embodiment, if the first model check operation 507 determines that the performance results comply with the performance levels rendered by the model, the operation flow passes to the next phase in the life cycle, and more specifically to a design system operation 508. If, however, the first model check operation 507 determines that the performance results do not comply with the performance levels rendered by the model, the operation flow passes back to the architecture design operation 506 and maintains within the architecture design phase 106 until the performance results of the architectural base complies with the performance levels.

In accordance with an alternative embodiment, the operation flow may move from the architecture design phase 106 into the system design phase 108 if the performance results, which are determined to not comply with the performance levels, are desired over the performance levels rendered by the model. In accordance with this embodiment, the model is refined based on the architectural base, and therefore the rendered performance levels are updated to reflect the performance results. After the model is refined in this manner, the operation flow proceeds to the system design operation 508.

The system design operation 508 encompasses one or more manual and/or computer-implemented processes performed during a system design phase of the life cycle of the IT-based system in accordance with an embodiment of the present invention. The system design operation 508 enhances the architectural base to provide for the specific application requested by the company for the IT-based computing system. To accomplish this, the system design operation 508 analyzes the architectural base designed by the architecture design operation 506 against the performance and functional requirements to specifically tailor the system to the application requested by the company. Based on this analysis, the system design operation 508 designs application specific system components for the IT-based computing system. These components may include, without limitation, application programming interfaces (API's), data structures and logic components. In an embodiment, the system design operation 508 establishes a performance budget prior to designing the application specific components. A performance budget is the degree to which the system, or individual components thereof, accomplish(es) designed functions within given constraints, such as speed, accuracy or memory usage. Once established, the performance budget is used as a guideline for defining the application specific components for the system. After the system design operation 508 selects the appropriate application specific components and thereafter enhances the architectural base with these selected components, the operation flow passes to a second model check operation 509.

The second model check operation 509 compares the performance levels rendered by the executed model against actual performance test results of the enhanced (i.e., with application specific components) base architecture. In an embodiment, the performance levels to which performance of the enhanced base architecture are compared reflect performance of the system expected at the system design phase 108, and not the operational phase 116. In another embodiment, the performance results taken from the enhanced architectural base may represent estimated operating parameters. In this embodiment, the performance levels to which the performance results are compared reflect performance of the system during operation.

In either embodiment, if the second model check operation 509 determines that the performance results comply with the performance levels rendered by the model, the operation flow passes to the next phase in the life cycle, and more specifically to a construct system operation 510. If, however, the second model check operation 509 determines that the performance results do not comply with the performance levels rendered by the model, the operation flow passes back to the system design operation 508 and maintains within the system design phase 108 until the performance results of the enhanced architectural base complies with the performance levels.

In accordance with an alternative embodiment, the operation flow may move from the system design phase 108 into the construct system operation 510 if the performance results, which are determined to not comply with the performance levels, are desired over the performance levels rendered by the model. In accordance with this embodiment, the model is refined based on the enhanced architectural base, and therefore the application specific components designed therein. Thus, the rendered performance levels are updated to reflect the performance results. After the model is refined in this manner, the operation flow proceeds to the construct system operation 510.

The construct system operation 510 encompasses one or more manual and/or computer-implemented processes performed during a construction phase of the life cycle of the IT-based system in accordance with an embodiment of the present invention. The construct system operation 510 constructs the actual hardware platform and software platform for use in the system. That is, the construct system operation 510 builds the actual IT-based computing system using the base architectural components selected by the architecture design operation 506 and the application-specific components selected by the system design operation 508. To accomplish this, the construct system operation 510 first builds the hardware platform for the system using all hardware components selected by the architecture design operation 506 and the system design operation 508. Next, the construct system operation 510 builds the software platform by interconnecting all software components selected by the architecture design operation 506 and the system design operation 508. Finally, the software platform is loaded into the software platform to render a complete IT-based computing system. Following construction of the system, the operation flow passes to a third model check operation 511.

The third model check operation 511 compares the performance levels rendered by the model against actual performance test results of the constructed IT-based computing system. In an embodiment, the performance levels to which performance of the constructed IT-based computing system are compared reflect performance of the system expected at conclusions of the construction phase 110, and not the operational phase 116. In another embodiment, the performance results taken from the constructed IT-based computing system may represent estimated operating parameters. In this embodiment, the performance levels to which the performance results are compared reflect performance of the system during operation.

In either embodiment, if the third model check operation 511 determines that the performance results comply with the performance levels rendered by the model, the operation flow passes to the next phase in the life cycle, and more specifically to a functionality test 512. If, however, the third model check operation 511 determines that the performance results do not comply with the performance levels rendered by the model, the operation flow passes back to the construct system operation 510 and maintains within the construction phase 110 until the performance results of the constructed IT-based computing system comply with the performance levels.

In accordance with an alternative embodiment, the operation flow may move from the construction phase 110 into the functionality test 512 if the performance results, which are determined to not comply with the performance levels, are desired over the performance levels rendered by the model. In accordance with this embodiment, the model is refined based on the constructed IT-based computing system, and therefore the software and hardware platform implemented therein. Thus, the rendered performance levels are updated to reflect the performance results. After the model is refined in this manner, the operation flow proceeds to the functionality test 512.

The functionality test 512 encompasses one or more manual and/or computer-implemented processes performed during a test phase of the life cycle of the IT-based system in accordance with an embodiment of the present invention. The functionality test 512 evaluates the constructed IT-based computing system to determine whether the system satisfies the functional requirements set out for the system. In an embodiment, the functionality test 512 evaluates the software and hardware platforms, and components thereof, to make sure that these platforms properly operate together in the manner anticipated by the architects and designers. As such, the functionality test 512 is a process that ensures that each component in the hardware and software platforms work to not only satisfy the functional requirements set out in the analysis operation 504, but also as anticipated during design and creation. If, at any time during the functionality test 512, the IT-based computing system does not function as required or anticipated, a troubleshooting process is implemented to determine the cause of the malfunction. Once identified, the malfunction is corrected in order for the system to function properly. The functionality test 512 is completed upon determining that the IT-based computing system functions as required and anticipated. Following the functionality test 512, the operation flow passes to a system performance test 514.

The system performance test 514 evaluates the functionally-tested IT-based computing system to determine whether the system meets all performance requirements expected for the system. The system performance test 514 is the final performance check prior to system deployment. In an embodiment, the system performance test 514 compares the performance levels rendered by the model against actual performance test results of the functionally-tested IT-based computing system. In an embodiment, the performance levels to which performance of the functionally-tested constructed IT-based computing system are compared reflect performance of the system expected at system deployment.

If the system performance test 514 determines that the performance results comply with the performance levels rendered by the model, the operation flow passes to the next phase in the life cycle, and more specifically to a deployment operation 516. If, however, the system performance test 514 determines that the performance results do not comply with the performance levels rendered by the model, the operation flow passes back to the functional test 512 and maintains within the testing phase 112 until the performance results of the IT-based computing system comply with the performance levels. In accordance with another embodiment, the operation flow may pass to any one of the design architecture operation 506, the system design operation 508 or the construct system operation 510, if the reasoning behind the system not passing the performance test 514 relates to a process performed during one of these operations.

In accordance with an alternative embodiment, the operation flow may pass from the performance test operation 514 to the deployment operation 516 if the performance results, which are determined to not comply with the performance levels, are desired over the performance levels rendered by the model. In accordance with this embodiment, the model is refined based on the functionally-tested IT-based computing system. Thus, the rendered performance levels are updated to reflect the performance results. After the model is refined in this manner, the operation flow proceeds to the deployment operation 516.

The deployment operation 516 encompasses one or more manual and/or computer-implemented processes performed during a deployment phase of the life cycle of the IT-based system in accordance with an embodiment of the present invention. The deployment operation 516 operates the performance-tested IT-based computing system in an actual production environment. In an embodiment, the production environment into which the system is deployed initially includes a limited number of users and operating conditions. The deployment operation 516 monitors performance of the system under actual live conditions to generate performance results for the system under these live conditions. The deployment operation 516 then compares the performance results to performance levels rendered by the model. As such, the deployment operation 516 not only monitors actual operation of the system, but also performs the performance checking at the time of system deployment.

If the deployment operation 516 determines that the performance results of the deployed system comply with the performance levels rendered by the model, the operation flow passes to the next phase in the life cycle, and more specifically to the implement operation 518. It should be appreciated that, at this phase in the life cycle, the performance results of the deployed system are expected to satisfy the performance levels rendered by the model due to the fact that the system has already undergone various performance checks/tests throughout its life cycle. If, however, the deployment operation 516 determines that the performance results do not comply with the performance levels rendered by the model, the operation flow may pass to any one of the design architecture operation 506, the system design operation 508 or the construct system operation 510, if the reasoning behind the system not passing the performance test 514 relates to a process performed during one of these operations.

In accordance with an another embodiment, the operation flow may pass from the deployment operation 516 to the implement operation 518 even if the performance results, which are determined to not comply with the performance levels, are desired over the performance levels rendered by the model. In accordance with this embodiment, the model is refined based on the deployed system. Thus, the rendered performance levels are updated to reflect the performance results. After the model is refined in this manner, the operation flow proceeds to the implement operation 518.

The implement operation 518 encompasses one or more manual and/or computer-implemented processes performed during an operation phase of the life cycle of the IT-based system in accordance with an embodiment of the present invention. The implement operation 518 initiates and maintains the IT-based computing system in full-scale operation in the production environment. Once system operation is initiated, the operation flow passes from the implement operation 518 to a performance check operation 519. The performance check operation 519 monitors performance of the system under operating conditions to generate performance results for the system. The deployment operation 516 then compares the performance results to performance levels rendered by the model. If the performance check operation 519 determines that the performance results do not comply with the performance levels rendered by the model, the operation flow passes to a transmit alert operation 520. The transmit alert operation 520 transmits an alert to personnel responsible for system operation that the system is malfunctioning. Such an alert may be transmitted by any conventional communication means, including, without limitation, pager, email, telephone (cell and land-based), facsimile, etc. From the transmit alert operation 520, the operation flow passes back to the implement operation 518 and continues as previously described.

If the performance check operation 519 determines that the performance results comply with the performance levels rendered by the model, the operation flow passes back to the implement operation 518. The implement operation 518 then monitors system operation to create a new set of performance results and the operation flow passes back to the performance check operation 519. The operation flow thereafter continues passing between the implement operation 518 and the performance check operation 519 until either a set of performance results fail to comply with the performance levels rendered by the model or the end of the life cycle is attained.

Referring now to FIG. 6, a process 600 for refining the performance model of an IT-based computing system during the life cycle, e.g., 100 of the system is shown in accordance with an embodiment of the present invention. Although monitoring the IT-based computing system for compliance with the performance model is not explicitly described with reference to the refinement process 600, it should be appreciated that an embodiment of the invention contemplates monitoring the design, creation, deployment and implementation of the IT-based computing system throughout each phase in the life cycle.

A process illustrating in more detail operations for monitoring the IT-based computing system for compliance with the performance model throughout the life cycle of the system is shown in FIGS. 4 and 5, supra. The monitoring process (400 and 500) illustrated in FIGS. 4 and 5 may indeed be performed concurrently with the refinement process 600 in accordance with an embodiment of the present invention. In this embodiment, the performance model, which as described in more detail below, is refined following each phase in the system's life cycle, is compared to performance levels derived at the conclusion of each subsequent phase, i.e., after the previous refinement, in the life cycle 100.

The refinement process 600 is performed using an operation flow initiated at the beginning 602 of the life cycle 100 for a conceptual IT-based computing system. At this point in time, the IT-based computing system is therefore represented as an “idea” for implementation by a company. After conception of the IT-based computing system, the operation flow passes to an analysis operation 604. The analysis operation 604 encompasses one or more manual and/or computer implemented processes implemented during an analysis phase of the life cycle of the IT-based system in accordance with an embodiment of the present invention. The purpose of the analysis operation 604 is to gain an understanding of not only the functional requirements for the IT-based computing system, but also the performance requirements in accordance with an embodiment of the present invention.

After the functional and performance requirements are defined by the analysis operation 604, the operation flow passes to a create model operation 606. The create model operation 606 creates the initial performance model for the IT-based computing system under construction. In an embodiment, the create model operation 606 uses the functional and performance requirements defined during the analysis operation 604 to create the initial performance model. As such, the initial performance model is built as early in the IT-based computing system's life cycle as possible, and therefore is based on early level requirements established prior to initial design of the system. In accordance with an embodiment, the performance model is constructed using discrete event simulation modeling software. From the create model operation 606, the operation flow passes to a refinement operation 608.

The refinement operation 608 encompasses one or more manual and/or computer-implemented processes performed during an architecture design phase, a system design phase, a construction phase and a test phase of the life cycle of the IT-based system in accordance with an embodiment of the present invention. The refinement operation 608 refines the performance model based on information gathered during each of these phases of the system's life cycle 100. The refinement operation 608 refines the performance model to reflect the components, both software and hardware, and functionality of the system in the current phase after the system is deemed to perform at the desired levels for that phase. Further, refinement operation 608 may even update the performance model to reflect the performance levels of the system in the current phase if it is determined that the actual performance levels are desired over the performance levels rendered by the model. After the performance model has been refined to reflect the system at each of the phases within the design and creation of the system, the operation flow passes to a deploy operation 610.

The deploy operation 610 encompasses one or more manual and/or computer-implemented processes performed during a deployment phase of the life cycle of the IT-based system in accordance with an embodiment of the present invention. The deploy operation 610 monitors the system as it is deployed first to a limited audience and subsequently to the intended production environment. To accomplish this, the deployment operation 410 applies the current performance model, i.e., the model as it is refined following the refinement operation 608, to the deployed IT-based computing system. If the performance levels are satisfied, the operation flow passes to the implement operation 612. If, however, the performance levels are not satisfied, the operation flow continues at the deployment operation 610 until either the IT-based computing system or the performance model are refined such that the system complies with the performance model. It should be appreciated, as stated, that the model, the actual IT-Based computing system or both may be refined in accordance with various embodiments. As such, there are circumstances where the model my be refined, but not the actual system. In these circumstances, the deployment operation 610 may have determined that the actual performance levels are desired over the performance levels rendered by the model. The deployment operation 610 may therefore refine the model during deployment to accurately reflect the performance levels actually rendered by the operating system. Upon agreement between actual operation of the deployed system and the service levels rendered by the performance model, the operation flow passes to the implement operation 612.

The implement operation 612 operates the deployed IT-based computing system in the intended production environment. The implement operation 612 encompasses one or more manual and/or computer-implemented processes performed during an operational phase of the life cycle of the IT-based system in accordance with an embodiment of the present invention. The implement operation 612 either periodically or randomly monitors actual operation of the IT-based computing system to derive performance results therefrom. If software or hardware components are added to the system during operation, then information related to such refinement is placed into the performance model, thereby resulting in a refined model during operation. The implementation operation 612 continues such operation and refinement until the end 614 of the system's life cycle.

Referring now to FIG. 7, shown therein is a procedural flow diagram (700) illustrating operational characteristics of the refinement process 600 in more detail in accordance with an embodiment of the present invention. More specifically, the refinement procedure 700 illustrates interaction between the refinement process 600 and operations occurring in each of the various phases of the life cycle, e.g., 100, of an IT-based computing system. These operations include an analysis operation 704, a create model operation 705, an architecture design operation 706 and a system design operation 708 which are substantially identical to the analysis operation 504, the create model operation 505, the architecture design operation 506 and the system design operation 508, respectively. As such, the description of these operations is not duplicated when describing the refinement procedure 700 below.

The refinement procedure 700 begins with a start operation 702 initiated at the beginning of the life cycle 100 for a conceptual IT-based computing system. At this point in time, the IT-based computing system is therefore represented as an “idea” for implementation by a company. After conception of the IT-based computing system, the operation flow passes to the following operations in the following order: the analysis operation 704, the create model operation 705, the architecture design operation 706. From the architecture design operation 706, the operation flow passes to a first refine model operation 707.

The first refine model operation 707 refines the performance model created by the create model operation 705 with information regarding the software and hardware infrastructure selected by the architecture design operation 706. After the performance model is defined, the operation flow passes to the system design operation 708. From the system design operation 708, the operation flow passes to a second refine model operation 709. The second refine model operation 709 refines the performance model, which had been previously refined by the first refine model operation 707, with information regarding the application specific components added to the system by the system define operation 708. From the second refine model operation 709, the operation flow passes to the construction operation 710.

The construction operation 710 constructs the actual hardware platform and software platform for use in the system. That is, the construction operation 710 builds the actual IT-based computing system using the base architectural components selected by the architecture design operation 706 and the application-specific components selected by the system design operation 708. In an embodiment, the construction operation 710 is performed using various operations (710a-710e) that work together to construct the IT-based computing system in unit-by-unit, or sub-system by sub-system, fashion. Upon passing to the construction operation 710, the operation flow begins at an assemble operation 710a. The assemble operation 710a is the operation in which all components—hardware, software and middleware—are interconnected to render a complete IT-based computing system. To accomplish this, the assemble operation 710a first builds the hardware platform for the system by interconnecting all hardware components selected by the architecture design operation 706 and the system design operation 708. Next, the assemble operation 710a builds the software platform by interconnecting all software components selected by the architecture design operation 706 and the system design operation 708. In an embodiment, the software platform includes a set of primary components, such as, database systems, operating systems and middleware. and a set of secondary components which represent the business logic associated with the system. The secondary components may take the form of data base stored procedures, executable program code (Cobol, assembler, C, Java, etc) or business rules developed for a rules based engine. Finally, the assemble operation 710a loads the software platform into the hardware platform to render a complete IT-based computing system.

At various times during the assemble operation 710a after at least two components—software, hardware and/or middleware—have been connected in furtherance of rendering a complete IT-based computing system, the operation flow branches to a sub-system performance test 710b. The sub-system performance test 710b applies various workload scenarios to the system under construction in order to determine whether the system will comply with performance requirements defined in the analysis operation 704. In accordance with an embodiment, performance related information rendered by the system responsive to application of these workload scenarios is compared to performance levels rendered in response to execution of the model under the same workload scenarios. From the sub-system performance test 710b, the operation flow passes to first query operation 710c. The first query operation 710c determines whether the system, as it currently stands under construction, passes the workload scenarios applied thereto by the sub-system performance test 710b. To accomplish this, the first query operation 710c analyzes the performance related information rendered by the system responsive to each workload scenario to the performance levels rendered by the model respective to the same workload scenario to determine whether the performance related information is within a certain range of the performance levels. If so, the system is considered to pass each of the workload scenarios.

If the system does not pass each workload scenario, a troubleshooting procedure is initiated that identifies the appropriate phase in the life cycle for correcting the malfunction. The operation flow then passes to either the architecture design operation 706, system operation 708 or the construction operation 710, whichever is the appropriate operation to correct the malfunction identified by the troubleshooting procedure. The potential passing of the operation flow to these alternative operations 706, 708 and 710 is shown in dashed lines. If, however, the system, as it currently stands under construction, passes each of the workload scenarios, the operation flow passes to a fourth refine model operation 710d. The fourth refine model operation 710d updates the model with information related to the construction of the current system, i.e., the way the system looks at this point in time. From the fourth refine model operation 710d, the operation flow passes to a second query operation 710e. The second query operation 710e determines whether the construction of the IT-based computing system is complete, i.e., whether all components are interconnected and performing as expected. In an embodiment, such a determination is made responsive to input from a user responsible for system construction. If construction of the IT-based computing system is not complete, the operation flow passes back to the assemble operation 710a and continues as previously described. If, however, construction is complete, the operation flow passes to a system performance test 715.

The system performance test 715 is identical to the performance test 514 of the monitoring procedure 500 shown in FIG. 5. As such, description of the processes associated with the performance testing is not duplicated with respect to describing FIG. 7. If the system fails the system performance test 715, the operation flow passes to the architecture design operation 706 and continues as described above in accordance with an embodiment. In accordance with other embodiments, the operation flow may pass to the analysis operation 704, the system design operation 708 or the construction operation 710 upon failure of the performance test 714. If the system passes the system performance test 715, the operation flow passes to the fifth refine model operation 717. The fifth refine model operation 717 refines the model with information gathered about the system during the system performance test 717.

From the fifth refine model operation 717, the operation flow passes to a deploy operation 716. The deploy operation 716 encompasses one or more manual and/or computer-implemented processes performed during a deployment phase of the life cycle of the IT-based system in accordance with an embodiment of the present invention. The deploy operation 716 monitors the system as it is deployed first to a limited audience and subsequently to the intended production environment. To accomplish this, the deployment operation 716 applies the current performance model, i.e., the model as it is refined, to the deployed IT-based computing system. If the performance levels are satisfied, the operation flow passes to the implement operation 718. If, however, the performance levels are not satisfied, the operation flow continues at the deployment operation 610 until either the IT-based computing system or the performance model are refined such that the system complies with the performance model. If the IT-based computing system is enhanced with additional hardware or software components, or if components are redacted from the system, the deploy operation 716 refines the performance model to reflect this change to the system.

It should be appreciated, as stated, that the model, the actual system or both may be refined in accordance with various embodiments. As such, there are circumstances where the model my be refined, but not the actual system. In these circumstances, the deployment operation 716 may have determined that the actual performance levels are desired over the performance levels rendered by the model. The deployment operation 716 may therefore refine the model during deployment to accurately reflect the performance levels actually rendered by the operating system. Upon agreement between actual operation of the deployed system and the service levels rendered by the performance model, the operation flow passes to the implement operation 718.

The implement operation 718 operates the deployed IT-based computing system in the intended production environment. The implement operation 718 encompasses one or more manual and/or computer-implemented processes performed during an operational phase of the life cycle of the IT-based system in accordance with an embodiment of the present invention. The implement operation 718 either periodically or randomly monitors actual operation of the IT-based computing system to derive performance results therefrom. From the implement operation 718, the operation flow passes to a sixth refine model operation 719. The sixth refine model operation 719 refines the performance model with information related to any workload changes affecting the system. Furthermore, the sixth refine model operation 719 refines the performance model with information related to any components, hardware and/or software, added to the system during operation. From the sixth refine model operation 710, the operation flow passes back to the implement operation 718 and continues as previously described until the end of the life cycle. As such, after the life cycle reaches the operational phase 116, the operational flow continuously passes between the implement operation 718 and the sixth refine operation 719 throughout the remainder of the life cycle.

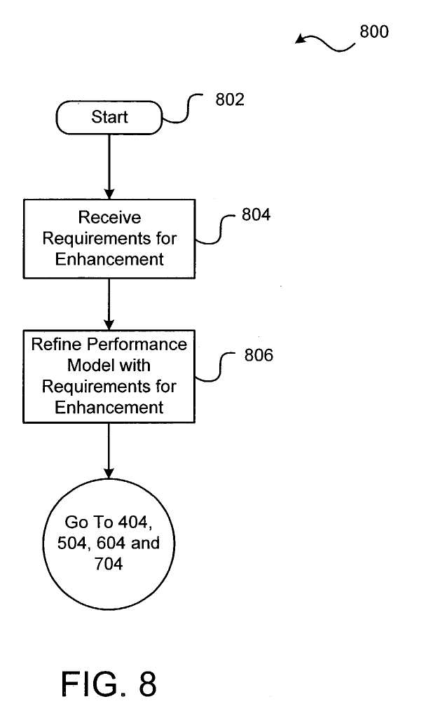

Referring now to FIG. 8, shown therein is a flow diagram that illustrates operational characteristics for enhancing an existing IT-based computing system using the performance model created and refined by the process shown in FIGS. 6 and 7 in accordance with an embodiment of the present invention. The enhancement procedure 800 begins at a start operation 802 as a company currently implementing an IT-based computing system conceives enhancing the current system. Such enhancements may be made to add new hardware or software components to the system after the system has been operating in the production environment or in an attempt to have improved functionality. From the start operation 802, the operation flow passes to a receive operation 804.

The receive operation 804 receives requirements for the enhancement(s) established by the company during conception of this project. An example of such requirements may be the added external functionality and security needed for a network in response to the addition of a branch office in a separate geographic area. After the enhancement requirements are established, the operation flow passes to a refine model operation 806. The refine model operation 806 refines the performance model for the IT-based computing system to include the enhancement requirements, which, in an embodiment, are similar, if not the same, to performance requirements. After the enhancements have been added to the performance model, the operation flow passes to an analysis operation, such as analysis operations 404, 504, 604 and 704, and the monitoring (400 and 500) and/or refining (600 and 700) processes are repeated.

It will be clear that the present invention is well adapted to attain the ends and advantages mentioned, as well as those inherent therein. While a presently preferred embodiment has been described for purposes of this disclosure, various changes and modifications may be made which are well within the scope of the present invention. For example, the refinement procedure 700 may include a functionality test, which, encompasses one or more manual and/or computer-implemented processes performed during a test phase of the life cycle of the IT-based system in accordance with an embodiment of the present invention. In this embodiment, the refinement test evaluates the constructed IT-based computing system to determine whether the system satisfies the functional requirements set out for the system. In this embodiment, the functionality test evaluates the software and hardware platforms, and components thereof, to make sure that these platforms properly operate together in the manner anticipated by the architects and designers. As such, the functionality test is a process that ensures that each component in the hardware and software platforms work to not only satisfy the functional requirements set out in the analysis operation 704, but also as anticipated during design and creation. If the IT-based computing system does not function as required or anticipated, a troubleshooting procedure is initiated that identifies the appropriate phase in the life cycle for correcting the malfunction. Numerous other changes may be made which will readily suggest themselves to those skilled in the art and which are encompassed in the spirit of the invention disclosed and as defined in the appended claims.

What is claimed is:

1. A method for monitoring performance of an information technology (IT) based computing system during a time period beginning with conception of the IT-based computing system and ending at a predefined time occurring after deployment of the IT-based computing system into a production environment, the method comprising:
creating a model of the IT-based computing system using one or more performance requirements defined for the IT-based computing system, wherein the model is a computer generated representation of the IT-based computing system at the time of deployment into the production environment; and
refining the model after deployment of the IT-based computing system into the production environment based on information collected from the IT-based computing system during operation in the production environment.

2. A method as defined in claim 1, wherein the performance requirements are defined during an analysis phase occurring during the time period after conception of the IT-based computing system and prior to any creation phases wherein the IT-based computing system is designed and constructed, the creating act comprising:
creating the model during the analysis phase.

3. A method as defined in claim 2, wherein the creation phases comprise an initial design phase wherein various software and hardware components used to construct the system are defined, the method further comprising:
refining the model after the initial design phase such that the model reflects the various software and hardware components defined during the design phase.

4. A method as defined in claim 3, wherein the creation phases comprise a subsequent design phase wherein application specific components used to construct the system are defined, the method further comprising:
refining the model after the subsequent design phase such that the model reflects the application specific components defined during the subsequent design phase.

5. A method as defined in claim 4, wherein the creation phases comprise a construction phase wherein the software components, hardware components and application specific components are interconnected and evaluated to determine whether additional components are needed to render the IT-based computing system in completed form, the additional components being integrated into the system during the construction phase to complete the IT-based computing system, wherein the method further comprises:
refining the model after the construct phase such that the model accurately represents the completed IT-based computing system.

6. A method as defined in claim 1, further comprising:
executing the model to render performance levels indicative of the performance requirements defined for the IT-based computing system;
executing the IT-based computing system to render performance metrics associated with performance of the IT-based computing system in the production environment; and
comparing the performance levels to the performance metrics to determine whether implementation of the IT-based system complies with the defined performance requirements.

7. A method as defined in claim 6, further comprising:
determining that implementation of the of the IT-based system complies with the defined performance requirements if the performance metrics are within a predetermined range of the performance levels.

8. A method as defined in claim 6, further comprising:
determining that implementation of the of the IT-based system complies with the defined performance requirements if the performance metrics are greater than or equal to the performance levels.

9. A method as defined in claim 6, wherein prior to the refining act, the IT-based computing system is enhanced with one or more components if implementation of the IT-based system is determined to not comply with the defined performance requirements.

10. A method as defined in claim 9, wherein the one or more components used to enhance the IT-based computing system are selected from the group consisting of hardware components, software components and middleware components.

11. A method as defined in claim 10, wherein the refining act comprises:
updating the model to reflect that the IT-based computing system has been enhanced with the one or more components.

12. A method as defined in claim 1, wherein after deployment and prior to the refining act, the IT-based computing system is enhanced with one or more components during implementation of the IT-based computing system in the production environment, the one or more components being selected from the group consisting of hardware components, software components and middleware components.

13. A method as defined in claim 11, wherein the refining act comprises:
updating the model to reflect that the IT-based computing system has been enhanced with the one or more components.

14. A method as defined in claim 1, further comprising:
refining the performance model to reflect desired enhancements to the IT-based computing system.

15. A method as defined in claim 14, wherein the desired enhancements relate to desired performance levels, wherein the refined performance model is operable for use in determining additional components required for the IT-based computing system to meet the desired enhancements.

16. A method as defined in claim 15, wherein the desired enhancements relate to additional components that are to be added to the IT-based computing system, the additional components being selected from a group consisting of hardware components, software components and middleware components, wherein the refined performance model is operable for use in predicting whether implementation of the IT-based computing system enhanced with the additional components will comply with the defined performance requirements.

17. A method for monitoring performance of an information technology (IT) based computing system during a time period beginning with conception of the IT-based computing system and ending at a predefined time occurring after deployment of the IT-based computing system into a production environment, the method comprising:
constructing a performance model of the IT-based computing system prior to deployment into the production environment, wherein the performance model is a computer generated representation of the IT-based computing system;
following deployment of the IT-based computing system into the production environment, executing the performance model to render performance levels indicative of the performance requirements defined for the IT-based computing system;
executing the IT-based computing system to render performance metrics associated with performance of the IT-based computing system in the production environment; and
comparing the performance levels to the performance metrics to determine whether implementation of the IT-based system complies with the defined performance requirements.

18. A method as defined in claim 17, wherein the constructing act comprises:
creating the performance model using one or more performance requirements defined for the IT-based computing system; and
refining the performance model based on information collected from the IT-based computing system during one or more creation phases occurring prior to deployment of the IT-based computing system into the production environment.

19. A method as defined in claim 17, further comprising:
determining that implementation of the of the IT-based system complies with the defined performance requirements if the performance metrics are within a predetermined range of the performance levels.

20. A method as defined in claim 17, further comprising:
determining that implementation of the of the IT-based system complies with the defined performance requirements if the performance metrics are greater than or equal to the performance levels.

21. A method as defined in claim 17, wherein prior to the refining act, the IT-based computing system is enhanced with one or more components if implementation of the IT-based system is determined to not comply with the defined performance requirements.

22. A method as defined in claim 21, wherein the one or more components used to enhance the IT-based computing system are selected from the group consisting of hardware components, software components and middleware components.

23. A method as defined in claim 22, further comprising:
updating the performance model to reflect that the IT-based computing system has been enhanced with the one or more components.

24. A method as defined in claim 17, wherein the constructing act is accomplished using a discrete event simulation software application program.

25. A method as defined in claim 17, further comprising:
refining the performance model to reflect desired enhancements to the IT-based computing system.

26. A method as defined in claim 25, wherein the desired enhancements relate to desired performance levels, wherein the refined performance model is operable for use in determining additional components required for the IT-based computing system to meet the desired enhancements.

27. A method as defined in claim 26, wherein the desired enhancements relate to additional components that are to be added to the IT-based computing system, the additional components being selected from a group consisting of hardware components, software components and middleware components, wherein the refined performance model is operable for use in predicting whether implementation of the IT-based computing system enhanced with the additional components will comply with the defined performance requirements.

28. A method for developing an information technology (IT) based computing system for use in a production environment, the method comprising:
creating a computer-implemented model of the IT-based computing system using one or more performance requirements defined for the IT-based computing system, wherein the computer-implemented model renders performance levels for the IT-based computing system when executed;
comparing operating parameters of the IT-based computing system after each of a plurality of phases during a period in time associated with creation of the IT-based computing system to performance levels rendered by the executed computer-implemented model to predict whether performance resulting from implementation of the IT-based computing system in the production environment will satisfy the one or more performance requirements; and
if it is predicted that performance resulting from implementation of the IT-based computing system in the production environment will satisfy the one or more performance requirements, refining the computer-implemented model after each of the plurality of phases such that the computer-implemented model reflects components and interconnectivity thereof for the IT-based computing system after each of the plurality of phases.

29. A method as defined in claim 28, wherein the performance requirements are defined during an analysis phase, the analysis phase occurring after conception of the IT-based computing system and prior to any creation phases wherein the IT-based computing system is designed and constructed, the creating act comprising:
creating the computer-implemented model during the analysis phase.

30. A method as defined in claim 29, wherein the plurality of phases comprises an architecture design phase occurring immediately after the analysis phase, wherein various software and hardware components used to construct the system are defined during the architecture design phase, the refining act comprising:
refining the computer-implemented model after the architecture design phase such that the computer-implemented model reflects the various software and hardware components defined during the architecture design phase.

31. A method as defined in claim 30, wherein the plurality of phases comprises a system design phase occurring immediately after the architecture design phase, wherein application specific components used to construct the system are defined during the system design phase, the refining act further comprising:
refining the computer-implemented model after the system design phase such that the computer-implemented model reflects the application specific components defined during the system design phase.

32. A method as defined in claim 31, wherein the plurality of phases comprises a construction phase occurring immediately after the system design phase, wherein the software components, hardware components and application specific components are interconnected and evaluated to determine whether additional components are needed to render the IT-based computing system in completed form, the additional components being integrated into the system during the construction phase to complete the IT-based computing system, wherein the refining act further comprises:
refining the computer-implemented model after the construction phase such that the computer-implemented model accurately reflects the completed IT-based computing system.

33. A method as defined in claim 28, further comprising:
refining the computer-implemented model after deployment of the IT-based computing system into the production environment based on information collected from the IT-based computing system during operation in the production environment.

34. A method as defined in claim 33, further comprising:
executing the computer-implemented model to render performance levels indicative of the performance requirements defined for the IT-based computing system;
executing the IT-based computing system to render performance metrics associated with performance of the IT-based computing system in the production environment; and
comparing the performance levels to the performance metrics to determine whether implementation of the IT-based system complies with the defined performance requirements.

35. A method as defined in claim 34, further comprising:
determining that implementation of the IT-based system complies with the defined performance requirements if the performance metrics are within a predetermined range of the performance levels.

36. A method as defined in claim 34, further comprising:
determining that implementation of the IT-based system complies with the defined performance requirements if the performance metrics are greater than or equal to the performance levels.

37. A method as defined in claim 34, wherein prior to the act of refining the computer-implemented model after deployment of the IT-based computing system, the IT-based computing system is enhanced with one or more components if implementation of the IT-based system is determined to not comply with the defined performance requirements.

38. A method as defined in claim 37, wherein the one or more components used to enhance the IT-based computing system are selected from the group consisting of hardware components, software components and middleware components.

39. A method as defined in claim 38, wherein the refining act comprises:
updating the computer-implemented model to reflect that the IT-based computing system has been enhanced with the one or more components.

40. A method as defined in claim 28, further comprising:
returning creation of the IT-based computing system to an earlier phase in the period of time if it is predicted that performance resulting from implementation of the IT-based computing system in the production environment will not satisfy the one or more performance requirements.

41. A method as defined in claim 28, further comprising:
moving creation of the IT-based computing system to a subsequent phase in the period of time if it is predicted that performance resulting from implementation of the IT-based computing system in the production environment will satisfy the one or more performance requirements.

42. A method as defined in claim 28, wherein the refining act comprises:
if it is predicted that performance resulting from implementation of the IT-based computing system in the production environment will not satisfy the one or more performance requirements, refining the computer-implemented model to reflect components and interconnectivity thereof for the IT-based computing system after each of the plurality of phases if performance resulting from implementation of the IT-based computing system in the production environment is more desirable than the one or more defined performance requirements.

43. A computer program product encoding a computer program for executing on a computer system a computer process for monitoring performance of an information technology (IT) based computing system during a time period beginning with conception of the IT-based computing system and ending at a predefined time occurring after deployment of the IT-based computing system into a production environment, the method comprising:
creating a model of the IT-based computing system using one or more performance requirements defined for the IT-based computing system, wherein the model is a computer generated representation of the IT-based computing system at the time of deployment into the production environment; and
refining the model after deployment of the IT-based computing system into the production environment based on information collected from the IT-based computing system during operation in the production environment.

44. The computer program product of claim 43, wherein the performance requirements are defined during an analysis phase occurring during the time period after conception of the IT-based computing system and prior to any creation phases wherein the IT-based computing system is designed and constructed, the creating act comprising:
creating the model during the analysis phase.

45. The computer program product of claim 44, wherein the creation phases comprise an initial design phase wherein various software and hardware components used to construct the system are defined, the method further comprising:
refining the model after the initial design phase such that the model reflects the various software and hardware components defined during the design phase.

46. The computer program product of 45, wherein the creation phases comprise a subsequent design phase wherein application specific components used to construct the system are defined, the method further comprising:
refining the model after the subsequent design phase such that the model reflects the application specific components defined during the subsequent design phase.

47. The computer program product of claim 46, wherein the creation phases comprise a construction phase wherein the software components, hardware components and application specific components are interconnected and evaluated to determine whether additional components are needed to render the IT-based computing system in completed form, the additional components being integrated into the system during the construction phase to complete the IT-based computing system, wherein the method further comprises:
refining the model after the construct phase such that the model reflects the completed IT-based computing system.

48. The computer program product of claim 43, the computer process further comprising:
executing the model to render performance levels indicative of the performance requirements defined for the IT-based computing system;
executing the IT-based computing system to render performance metrics associated with performance of the IT-based computing system in the production environment; and
comparing the performance levels to the performance metrics to determine whether implementation of the IT-based system complies with the defined performance requirements.

49. The computer program product of claim 48, the computer process further comprising:
determining that implementation of the of the IT-based system complies with the defined performance requirements if the performance metrics are within a predetermined range of the performance levels.

50. The computer program product of claim 48, the computer process further comprising:
determining that implementation of the IT-based system complies with the defined performance requirements if the performance metrics are greater than or equal to the performance levels.

51. The computer program product of claim 48, wherein prior to the refining act, the IT-based computing system is enhanced with one or more components if implementation of the IT-based system is determined to not comply with the defined performance requirements.

52. The computer program product of claim 51, wherein the one or more components used to enhance the IT-based computing system are selected from the group consisting of hardware components, software components and middleware components.

53. The computer program product of claim 52, wherein the refining act comprises:
updating the model to reflect that the IT-based computing system has been enhanced with the one or more components.

54. The computer program product of claim 43, wherein after deployment and prior to the refining act, the IT-based computing system is enhanced with one or more components during implementation of the IT-based computing system in the production environment, the one or more components being selected from the group consisting of hardware components, software components and middleware components.

55. The computer program product of claim 53, wherein the refining act comprises:
updating the model to reflect that the IT-based computing system has been enhanced with the one or more components.

56. The computer program product of claim 43, the computer process further comprising:
refining the performance model to reflect desired enhancements to the IT-based computing system.

57. The computer program product of claim 14, wherein the desired enhancements relate to desired performance levels, wherein the refined performance model is operable for use in determining additional components required for the IT-based computing system to meet the desired enhancements.

58. The computer program product of claim 15, wherein the desired enhancements relate to additional components that are to be added to the IT-based computing system, the additional components being selected from a group consisting of hardware components, software components and middleware components, wherein the refined performance model is operable for use in predicting whether implementation of the IT-based computing system enhanced with the additional components will comply with the defined performance requirements.

59. A computer program product encoding a computer program for developing an information technology (IT) based computing system for use in a production environment, the computer process comprising:
creating a computer-implemented model of the IT-based computing system using one or more performance requirements defined for the IT-based computing system, wherein the computer-implemented model renders performance levels for the IT-based computing system when executed;
comparing operating parameters of the IT-based computing system after each of a plurality of phases during a period in time associated with creation of the IT-based computing system to performance levels rendered by the executed computer-implemented model to predict whether performance resulting from implementation of the IT-based computing system in the production environment will satisfy the one or more performance requirements; and
if it is predicted that performance resulting from implementation of the IT-based computing system in the production environment will satisfy the one or more performance requirements, refining the computer-implemented model after each of the plurality of phases such that the computer-implemented model reflects components and interconnectivity thereof for the IT-based computing system after each of the plurality of phases.

60. The computer program product of claim 59, wherein the performance requirements are defined during an analysis phase occurring after conception of the IT-based computing system and prior to any creation phases wherein the IT-based computing system is designed and constructed, the creating act comprising:
creating the computer-implemented model during the analysis phase.

61. The computer program product of claim 60, wherein the plurality of phases comprises an architecture design phase occurring immediately after the analysis phase, wherein various software and hardware components used to construct the system are defined during the architecture design phase, the refining act comprising:
refining the computer-implemented model after the architecture design phase such that the computer-implemented model reflects the various software and hardware components defined during the architecture design phase.

62. The computer program product of claim 61, wherein the plurality of phases comprises a system design phase occurring immediately after the architecture design phase, wherein application specific components used to construct the system are defined during the system design phase, the refining act further comprising:
refining the computer-implemented model after the system design phase such that the computer-implemented model reflects the application specific components defined during the system design phase.

63. The computer program product of claim 62, wherein the plurality of phases comprises a construction phase occurring immediately after the system design phase, wherein the software components, hardware components and application specific components are interconnected and evaluated to determine whether additional components are needed to render the IT-based computing system in completed form, the additional components being integrated into the system during the construction phase to complete the IT-based computing system, wherein the refining act further comprises:
refining the computer-implemented model after the construction phase such that the computer-implemented model accurately represents the completed IT-based computing system.

64. The computer program product of claim 59, the computer process further comprising:
refining the computer-implemented model after deployment of the IT-based computing system into the production environment based on information collected from the IT-based computing system during operation in the production environment.

65. The computer program product of claim 64, the computer process further comprising:
executing the computer-implemented model to render performance levels indicative of the performance requirements defined for the IT-based computing system;
executing the IT-based computing system to render performance metrics associated with performance of the IT-based computing system in the production environment; and
comparing the performance levels to the performance metrics to determine whether implementation of the IT-based system complies with the defined performance requirements.

66. The computer program product of claim 65, the computer process further comprising:
determining that implementation of the IT-based system complies with the defined performance requirements if the performance metrics are within a predetermined range of the performance levels.

67. The computer program product of claim 65, the computer process further comprising:
determining that implementation of the IT-based system complies with the defined performance requirements if the performance metrics are greater than or equal to the performance levels.

68. The computer program product of claim 65, wherein prior to the act of refining the computer-implemented model after deployment of the IT-based computing system, the IT-based computing system is enhanced with one or more components if implementation of the IT-based system is determined to not comply with the defined performance requirements.

69. The computer program product of claim 68, wherein the one or more components used to enhance the IT-based computing system are selected from the group consisting of hardware components, software components and middleware components.

70. The computer program product of claim 69, wherein the refining act comprises:
updating the computer-implemented model to reflect that the IT-based computing system has been enhanced with the one or more components.

71. The computer program product of claim 59, the computer process further comprising:
returning creation of the IT-based computing system to an earlier phase in the period of time if it is predicted that implementation of the IT-based computing system in the production environment will not satisfy the one or more performance requirements.

72. The computer program product of claim 59, the computer process further comprising:
moving creation of the IT-based computing system to a subsequent phase in the period of time if it is predicted that implementation of the IT-based computing system in the production environment will satisfy the one or more performance requirements.

73. The computer program product of claim 59, wherein the refining act comprises:
if it is predicted that performance resulting from implementation of the IT-based computing system in the production environment will not satisfy the one or more performance requirements, refining the computer-implemented model to reflect components and interconnectivity thereof for the IT-based computing system after each of the plurality of phases if it is predicted that performance resulting from implementation of the IT-based computing system in the production environment is more desirable than the one or more defined performance requirements.
